(19) United States
(12) Patent Application Publication
(10) Pub. No.: US 2026/0214336 A1
(43) Pub. Date: Jul. 23, 2026

(54) LENS DRIVING DEVICE AND LENS MODULE

(71) Applicant: AAC Microtech (Changzhou) Co., Ltd., Changzhou City (CN)

(72) Inventors: Zhang Ren, Changzhou (CN); Ronglin Linghu, Changzhou (CN); Wei Song, Changzhou (CN)

(21) Appl. No.: 19/326,711

(22) Filed: Sep. 11, 2025

Related U.S. Application Data
(63) Continuation of application No. PCT/CN2025/073515, filed on Jan. 21, 2025.

(51) Int. Cl. H04N 23/68; H04N 23/51; H04N 23/54; H04N 23/57

(52) U.S. Cl. CPC H04N 23/687; H04N 23/51; H04N 23/54; H04N 23/57

(57) ABSTRACT

The embodiment of this invention provides a lens driving device and lens module, the lens driving device includes a housing provided a bottom plate and an upper cover; a sensor assembly includes a circuit board, a sensor, and a drive assembly; the drive assembly includes a support frame, a magnetic circuit system, and a drive coil; an elastic support component includes a first connecting part, a second connection part, an abutting part, and an elastic arm, the drive coil driving the sensor assembly to move in the direction of an optic axis of the lens. In the present invention with the sensor assembly moving schemes, there is no need to reserve an extra moving space for the lens, the sensor assembly can move precisely in a small space, so increasing the size of the screen opening of the lens is unnecessary, the screen to body ratio can be effectively improved.

### CROSS-REFERENCE TO RELATED APPLICATIONS

This application is a continuation of International Application No. PCT/CN2025/073515 filed on Jan. 21, 2025, the entire contents of which are incorporated herein by reference.

### TECHNICAL FIELD

The present application relates to the technical field of photographing device, in particular to a lens driving device and lens module.

### BACKGROUND

At present, the cameras used on AR glasses are all designed with fixed focus and without any anti shake function due to size and weight limitations, therefore, small-sized anti shake design is necessary.

In anti-shake design, conventional lens moving schemes can cause the screen opening to become larger, which can affect the screen to body ratio. In addition, to adopt the lens moving scheme, a moving space is need to reserve for the lens movement inside the housing of the driving device, which is not conducive to the miniaturization design of the device.

Therefore, how to solve the above technical problems has become an urgent technical problem to the technicians in this field.

### SUMMARY

The embodiments of the present invention aim to solve at least one of the technical problems above, and provide a lens driving device and lens module.

The first aspect, an embodiment of this application provides a lens driving device, comprising:
a housing, the housing comprises a bottom plate and an upper cover that is covered on the bottom plate and enclosed to form an accommodation space with the bottom plate, the upper cover is provided with a photic hole communicated the accommodation space with the outside, the photic hole is used to communicate with a lens;
a sensor assembly, the sensor assembly located within the accommodation space, the sensor assembly comprises a circuit board and a sensor located on the side of the circuit board near the photic hole and electrically connected to the circuit board;
   a drive assembly, the drive assembly located within the accommodation space, the drive assembly comprises a support frame fixed on the bottom plate, a magnetic circuit system fixed on the bottom plate, and a drive coil, the magnetic circuit system has a magnetic gap;
an elastic support component, the elastic support component comprises a first connecting part fixed on the support frame, a second connection part fixed on the circuit board, an abutting part fixed on the bottom plate, and an elastic arm connecting the first connecting part and the second connection part, the elastic support component suspends the sensor assembly within the accommodation space;
the drive coil is located on the side of the second connection part away from the circuit board, and extends into the magnetic gap, the drive coil cooperates with the magnetic circuit system to be used for driving the sensor assembly to move in the direction of an optic axis of the lens.

In some embodiments, the magnetic circuit system comprises a first magnetic circuit component fixed on the bottom plate and a second magnetic circuit component set on the side of the first magnetic circuit component facing away from the bottom plate; the second magnetic circuit component is set with the magnetic gap.

In some embodiments, the first magnetic circuit component comprises a first outer ring magnet, a first inner ring magnet, and a non-magnetic area set between the first outer ring magnet and the first inner ring magnet; the first inner ring magnet is set on the inner side of the first outer ring magnet; wherein the magnetic pole direction of the first outer ring magnet is opposite from that of the first inner ring magnet.
the first magnetic circuit component is integrally formed using a quadrupole magnetization process.

In some embodiments, the second magnetic circuit component comprises a second outer ring magnet and a second inner ring magnet; the second inner ring magnet is set on the inner side of the second outer ring magnet; wherein the magnetic pole direction of the second outer ring magnet is opposite from that of the second inner ring magnet, and the second outer ring magnet and the second inner ring magnet are spaced apart from each other to form the magnetic gap.

In some embodiments, the first magnetic circuit component and the second magnetic circuit component are integrally formed using a quadrupole magnetization process.

In some embodiments, the magnetic circuit system also comprises a clamping plate located on the side of the second magnetic circuit component near the photic hole, the clamping plate is provided with a clamping plate notch communicated with the magnetic gap.

In some embodiments, the second connection part comprises a thickening part, the drive coil is fixed to the thickening part.

In some embodiments, the elastic arm comprises a first arm connected to the first connecting part, a second arm bent and extending from the first arm, and a third arm extending from the end of the second arm away from the first arm, the third arm is connected to the second connection part; the first arm and the third arm are oppositely arranged.

In some embodiments, two second connection parts have been set and are spaced apart from each other, each of the second connection part is fixedly connected to the drive coil, the two second connection parts are respectively connected to two different elastic arms, the extension directions of the third force arms in two different elastic arms are opposite to each other.

In some embodiments, the support frame comprises a side wall fixed on the bottom plate, a top wall bend and extending from the end of the side wall away from the bottom plate in the direction close to the optic axis, the side wall and the top wall are both fixedly connected to the magnetic circuit system.

In some embodiments, the support frame also comprises a connecting column extending from the top wall in the direction away from the bottom plate, the sensor assembly also comprises a connecting protrusion set on the side of the circuit board away from the bottom plate and an elastic component connecting the connecting protrusion and the connecting column.

In some embodiments, the first connecting part comprises a connecting side edge connected to the side wall and a connecting top edge connected to the top wall.

In some embodiments, the top wall comprises an avoidance part, using for avoiding the elastic arm.

The second aspect, an embodiment of this application provides a lens module, comprising:
a lens driving device of any one above-mentioned;
a lens, set at a through hole on the top of the housing, the lens is correspondingly set with the sensor assembly.

The beneficial effects of the present application are as follows:

In the present invention, and in the design of fixed focus and anti-shake which is taking the sensor assembly moving schemes, there is no need to reserve an extra moving space for the lens, the sensor assembly can move precisely in a small space, so increasing the size of the screen opening of the lens is unnecessary, the screen to body ratio can be effectively improved. In addition, compared with the existing lens movement schemes, the present invention with the sensor assembly moving schemes, as the sensor assembly can move in the direction of the optic axis directly, a larger range of optic axis adjustment can be achieved, allowing for a larger field of view (FOV) under the same screen opening size.

### BRIEF DESCRIPTION OF THE DRAWINGS

FIG. 1 is a structural view of a lens module according to an embodiment of the present invention.

FIG. 2 is a sectional view of the lens module as shown in FIG. 1 along a line A-A, in which the positional relationship between the sensor driving device, sensor components, and lens is shown.

FIG. 3 is an enlarged view of the partial structure of the lens module as shown in FIG. 2.

FIG. 4 is an exploded view of the lens module as shown in FIG. 1.

FIG. 5 is an overall structural view showing an elastic support component, a support frame and a sensor assembly in an embodiment of the present invention.

FIG. 6 is an overall structural view showing an elastic support component and a support frame in an embodiment of the present invention.

FIG. 7 is an exploded view of the structure with the elastic support component and the support frame as shown in FIG. 6.

FIG. 8 is an enlarged view of the partial structure of the elastic support component as shown in FIG. 6.

FIG. 9 is an overall structural view of the elastic support component in an embodiment of the present invention.

FIG. 10 is an exploded view of the magnetic circuit system as shown in FIG. 7.

FIG. 11 is a sectional view of the magnetic circuit system in an embodiment of the present invention; the magnetic poles of a first outer ring magnet, a first inner ring magnet, a second outer ring magnet and a second inner ring magnet are shown, in which the arrow direction is the direction from the S pole to the N pole.

FIG. 12 is an overall structural view of the elastic component in an embodiment of the present invention.

FIG. 13 is an exploded view of the sensor assembly as shown in FIG. 4.

In the figures, 100, lens module; 10, lens driving device; 20, sensor assembly; 30, lens; 11, housing; 12, elastic support component; 13, drive assembly; 111, accommodation space; 112, bottom plate; 113, photic hole; 114, bottom through hole; 115, upper cover; 121, first connecting part; 122, second connection part; 123, elastic arm; 1211, abutting part; 1212, connecting side edge; 1213, connecting top edge; 1221, thickening part; 1231, first arm; 1232, second arm; 1233, third arm; 131, support frame; 132, magnetic circuit system; 133, clamping plate; 134, drive coil; 1311, mounting cavity; 1312, through hole; 1313, side wall; 1314, top wall; 1315, connecting column; 13141, avoidance part; 1321, magnetic gap; 1322, first magnetic circuit component; 1323, second magnetic circuit component; 1324, central through hole; 13221, first outer ring magnet; 13222, first inner ring magnet; 13223, non-magnetic area; 13231, second outer ring magnet; 13232, second inner ring magnet; 1331, outer annular plate; 1332, inner annular plate; 1333, clamping plate notch; 1334, clamping plate through-hole; 21, circuit board; 22, sensor; 23, sensor support frame; 24, filter; 25, connecting protrusion; 26, elastic component; 261, first connecting component; 262, second connecting component; 263, bending elastic component; 31, optic axis.

### DETAILED DESCRIPTION OF THE EMBODIMENTS

In order to make the technicians in this field understand the technical solutions of the present invention better, the present invention will be further described in detail with reference to the accompanying drawings and specific embodiments.

The present invention will be further described in detail with reference to the accompanying drawings and specific embodiments. The detailed description and accompanying drawings of the following embodiments are used to exemplarily illustrate the principles of the present application, but cannot be used to limit the scope of the present application, that is, the present application is not limited to the described embodiments. In the description of this application, it should be noted that unless otherwise specified, the meaning of “multiple” refers to two or more; the terms “up”, “down”, “left”, “right”, “inside”, “outside” and other directional or positional relationships are only for the convenience of describing the present application and simplifying the description, and do not indicate or imply that the device or component referred to must have a specific orientation, be constructed and operated in a specific orientation, and therefore cannot be understood as limiting the present application. In addition, the terms “first”, “second”, etc. are only used for descriptive purposes and cannot be understood as indicating or implying relative importance. “Vertical” is not strictly vertical, but within the allowable range of error. “Parallel” is not strictly parallel, but within the allowable range of error.

In the description of this application, it should be noted further that unless otherwise specified and limited are given, the terms “installation”, “to be connected”, and “connection” should be broadly understood, for example, they can be fixed connections, detachable connections, or integral connections; it can be directly connected or indirectly connected through an intermediate medium. For ordinary technicians in this field, the specific meanings of the above terms in this application can be understood depending on the specific situation.

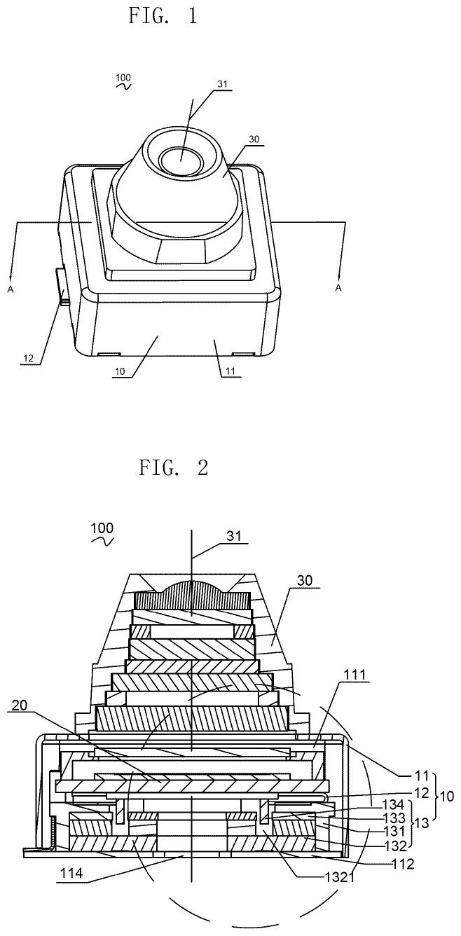

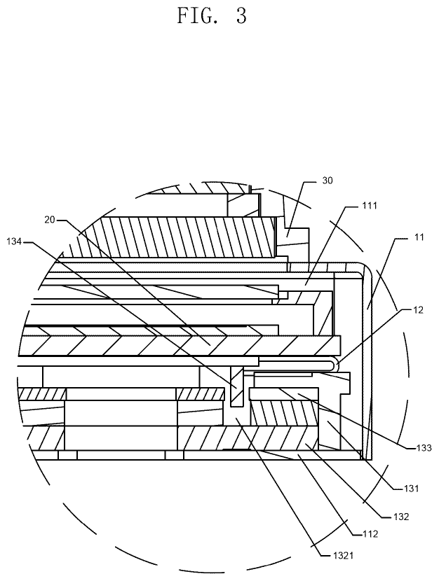

A lens driving device 10 is shown in FIG. 1 to FIG. 4, the lens driving device 10 includes a housing 11, an elastic support component 12, a drive assembly 13 and a sensor assembly 20. The housing 11 includes a bottom plate 112 and an upper cover 115 that is covered on the bottom plate 112 and enclosed to form an accommodation space 111 with the bottom plate 112, the upper cover 115 is provided with a photic hole 113 communicated the accommodation space 111 with the outside, the photic hole 113 is used to communicate with the lens 30.

The sensor assembly 20 located within the accommodation space 111, the sensor assembly 20 includes a circuit board 21 and a sensor 22 located on the side of the circuit board 21 near the photic hole 113 and electrically connected to the circuit board 21. The drive assembly 13 located within the accommodation space 111, the drive assembly 13 includes a support frame 131 fixed on the bottom plate 112, a magnetic circuit system 132 fixed on the bottom plate 112, and a drive coil 134, the magnetic circuit system 132 has a magnetic gap 1321.

### The Elastic Support Component 12 Includes a First Connecting Part 121 Fixed on the Support

frame 131, a second connection part 122 fixed on the circuit board 21, an abutting part 1211 fixed on the bottom plate 112, and an elastic arm 123 connecting the first connecting part 121 and the second connection part 122, the elastic support component 12 suspends the sensor assembly 20 within the accommodation space 111.

The drive coil 134 is located on the side of the second connection part 122 away from the circuit board 21, and extends into the magnetic gap 1321, the drive coil 134 cooperates with the magnetic circuit system 132 to be used for driving the sensor assembly 20 to move in the direction of an optic axis 31 of the lens 30.

In the present invention, and in the design of fixed focus and anti-shake which is taking the sensor assembly 20 moving schemes, there is no need to reserve an extra moving space for the lens 30, the sensor assembly 20 can move precisely in a small space, so increasing the size of the screen opening of the lens 30 is unnecessary, the screen to body ratio can be effectively improved. In addition, compared with the existing lens 30 movement schemes, the present invention with the sensor assembly 20 moving schemes, as the sensor assembly 20 can move in the direction of the optic axis 31 directly, a larger range of optic axis 31 adjustment can be achieved, allowing for a larger field of view (FOV) under the same screen opening size.

The axis of the photic hole 113 coincides with the optic axis 31 of the lens 30. Being supported by the elastic support component 12, the sensor assembly 20 is arranged along the direction of the optic axis 31 of the lens 30, and corresponds to the position of the lens 30.

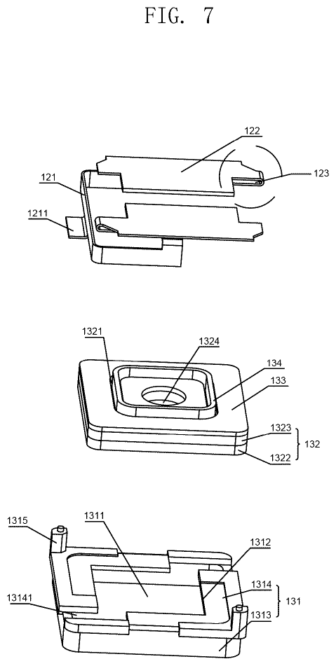

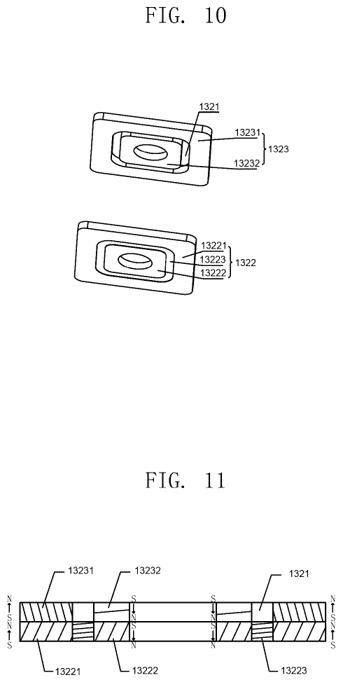

Referring to FIG. 7 and FIG. 10 to FIG. 11, in some embodiments, the magnetic circuit system 132 includes a first magnetic circuit component 1322 fixed on the bottom plate 112 and a second magnetic circuit component 1323 set on the side of the first magnetic circuit component 1322 facing away from the bottom plate 112, the second magnetic circuit component 1323 is set with the magnetic gap 1321.

Specifically, along the direction of optic axis 31 of lens 30, sensor assembly 20, drive coil 134, and magnetic circuit system 132 are arranged in sequence. Among them, the first magnetic circuit component 1322 and the second magnetic circuit component 1323 are stacked along the direction of optic axis 31 of lens 30. The second magnetic circuit component 1323 corresponds to the position of the drive coil, and a magnetic gap 1321 adapted to the shape of the drive coil 134 is provided on the surface of the second magnetic circuit component 1323 facing the drive coil 134.

In some embodiments, the first magnetic circuit component 1322 includes a first outer ring magnet 13221, a first inner ring magnet 13222, and a non-magnetic area 13223 set between the first outer ring magnet 13221 and the first inner ring magnet 13222. The first inner ring magnet 13222 is set on the inner side of the first outer ring magnet 13221, in which the magnetic pole direction of the first outer ring magnet 13221 is opposite from that of the first inner ring magnet 13222.

Specifically, the axis of the first outer ring magnet 13221 coincides with the axis of the first inner ring magnet 13222, in order to make the magnetic field distribution between the first outer ring magnet 13221 and the first inner ring magnet 13222 more uniform.

In one embodiment provided by the present invention, the first outer ring magnet 13221 and the first inner ring magnet 13222 are both rectangular ring-shaped, the first outer ring magnet 13221 has a rectangular inner ring space, while the first inner ring magnet 13222 has a circular inner ring space, in which the first inner ring magnet 13222 is set in the rectangular inner ring space of the first outer ring magnet 13221. Along the direction of optic axis 31, the magnetic pole direction of the first outer ring magnet 13221 points to the lens 30, while the magnetic pole direction of the first inner ring magnet 13222 deviates from the lens 30.

In some embodiments, the first magnetic circuit component 1322 is integrally formed using a quadrupole magnetization process. Specifically, along the direction of optic axis 31, an upper end face of the first outer ring magnet 13221 is set to be N pole, a lower end face of the first outer ring magnet 13221 is set to be S pole. An upper end face of the first inner ring magnet 13222 is set to be S pole, a lower end face of the first inner ring magnet 13222 is set to be N pole, in which the non-magnetic area 13223 is formed between the first outer ring magnet 13221 and the first inner ring magnet 13222, and the first outer ring magnetic steel 13221 and the first inner ring magnetic steel 13222 are integrally formed under a quadrupole magnetization process. It can be understood that quadrupole magnetization refers to magnetize the magnetic steel into four alternate magnetic poles (N-S-N-S), forming four magnetic pole regions. By taking the setting mode, the uniform distribution of magnetic field in multiple directions can be ensured, magnetic field distortion has been reduced. In addition, with better coordination between multipole magnetic field and the drive coil 134, more concentrated electromagnetic force, higher driving efficiency and response speed, and more easily achievable fine magnetic field control are providing, which helps to improve the accuracy and stability of the movement of the sensor assembly 20.

In some embodiments, the second magnetic circuit component 1323 includes a second outer ring magnet 13231 and a second inner ring magnet 13232; the second inner ring magnet 13232 is set on the inner side of the second outer ring magnet 13231, wherein the magnetic pole direction of the second outer ring magnet 13231 is opposite from that of the second inner ring magnet 13232, and the second outer ring magnet 13231 and the second inner ring magnet 13232 are spaced apart from each other to form the magnetic gap 1321.

Specifically, the axis of the second outer ring magnet 13231 coincides with the axis of the second inner ring magnet 13232, in order to make the magnetic field distribution between the second outer ring magnet 13231 and the second inner ring magnet 13232 more uniform.

In one embodiment provided by the present invention, the drive coil 134 is rectangular ring-shaped. The second outer ring magnet 13231 and the second inner ring magnet 13232 are both rectangular ring-shaped, the second outer ring magnet 13231 has a rectangular inner ring space, while the second inner ring magnet 13232 has a circular inner ring space, in which the second inner ring magnet 13232 is set in the rectangular inner ring space of the second outer ring magnet 13231. Along the direction of optic axis 31, the magnetic pole direction of the second outer ring magnet 13231 points to the lens 30, while the magnetic pole direction of the second inner ring magnet 13232 deviates from the lens 30.

In some embodiments, the first magnetic circuit component 1322 and the second magnetic circuit component 1323 are integrally formed using a quadrupole magnetization process. Specifically, along the direction of optic axis 31, an upper end face of the second outer ring magnet 13231 is set to be N pole, a lower end face of the second outer ring magnet 13231 is set to be S pole. An upper end face of the second inner ring magnet 13232 is set to be S pole, a lower end face of the second inner ring magnet 13232 is set to be N pole, and the second outer ring magnet 13231 and the second inner ring magnet 13232 are integrally formed under a quadrupole magnetization process. It can be understood that quadrupole magnetization refers to magnetize the magnetic steel into four alternate magnetic poles (N-S-N-S), forming four magnetic pole regions. By taking the setting mode, the uniform distribution of magnetic field in multiple directions can be ensured, magnetic field distortion has been reduced. In addition, with better coordination between multipole magnetic field and the drive coil 134, more concentrated electromagnetic force, higher driving efficiency and response speed, and more easily achievable fine magnetic field control are providing, which helps to improve the accuracy and stability of the movement of the sensor assembly 20.

The first specific embodiment provided by the present invention includes:
The second outer ring magnet 13231 and the second inner ring magnet 13232 of the second magnetic circuit component 1323 adopt a split design, the first outer ring magnet 13221 and the first inner ring magnet 13222 of the first magnetic circuit component 1322 are integrally formed using a quadrupole magnetization process. It can be understood that since the second outer ring magnet 13231 and the second inner ring magnet 13232 of the second magnetic circuit component 1323 adopt a split design, that is the second outer ring magnet 13231 and the second inner ring magnet 13232 are produced and formed separately, and the second magnetic circuit component 1323 is forming by assemble method.

The second specific embodiment provided by the present invention includes:
The second outer ring magnet 13231 and the second inner ring magnet 13232 of the second magnetic circuit component 1323 adopt a split design, the first outer ring magnet 13221 and the first inner ring magnet 13222 of the first magnetic circuit component 1322 adopt a split design. It can be understood that since the first outer ring magnet 13221 and the first inner ring magnet 13222 adopt a split design, that is the first outer ring magnet 13221 and the first inner ring magnet 13222 are produced and formed separately, and the first magnetic circuit component 1322 is forming by assemble method.

The third specific embodiment provided by the present invention includes:
The second outer ring magnet 13231 and the second inner ring magnet 13232 of the second magnetic circuit component 1323 are integrally formed using a quadrupole magnetization process, the first outer ring magnet 13221 and the first inner ring magnet 13222 of the first magnetic circuit component 1322 are integrally formed using a quadrupole magnetization process.

In some embodiments, the support frame 131 is rectangular shaped and has a mounting cavity 1311 that is adapted to the shape of the magnetic circuit system 132, and the magnetic circuit system 132 is set in the mounting cavity 1311. The magnetic circuit system 132 can be effectively fixed by using the mounting cavity 1311 of the support frame 131, the vibration mass can be effectively reduced and the degree of magnetic interference can be minimized.

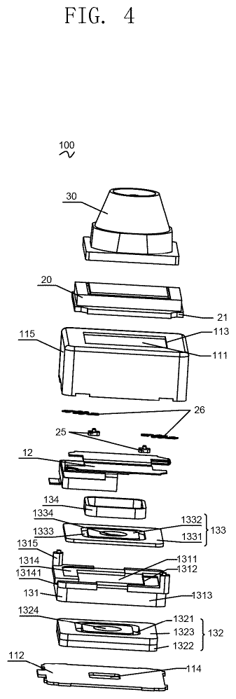

Specifically, continue to refer to FIG. 4 and FIG. 7, the support frame 131 also includes a through hole 1312 communicated with the mounting cavity 1311, the through hole 1312 corresponds to the position of the photic hole 113 and the bottom through hole 114 in the housing 11, and the through hole 1312 corresponds to the position of the magnetic gap 1321 in the magnetic circuit system 132. The drive coil 134 is set at the through hole 1312 by the supporting of the elastic support component 12, and corresponds to the position of the magnetic gap 1321. When there is electric current conducting in the drive coil 134, the drive coil 134 moves through the through hole 1312 in the direction of the optic axis 31 of the lens 30 under the action of force, synchronously the sensor assembly 20 is driven to move in the direction of the optic axis 31 of the lens 30, and focal length adjustment has been achieved.

In some embodiments, the bottom through hole 114 is set on the bottom plate 112, and there is a central through hole 1324 set in the magnetic circuit system 132, among them, the bottom through hole 114, the central through hole 1324, and the photic hole 113 are coaxially arranged. It can be understood that the inner space of the first inner ring magnet 13222 and the inner space of the second inner ring magnet 13232 are enclosed together to form the central through hole 1324.

In some embodiments, the magnetic circuit system 132 also includes a clamping plate 133 located on the side of the second magnetic circuit component 1323 near the photic hole 113, the clamping plate 133 is provided with a clamping plate notch 1333 communicated with the magnetic gap 1321.

Specifically, the clamping plate 133 is clamped between the top of the mounting cavity 1311 and the magnetic circuit system 132, using to fix the magnetic circuit system 132 inside the support frame 131, in which the clamping plate 133 is provided with a clamping plate notch 1333 which is compatible with the size of the magnetic gap 1321. The clamping plate 133 includes an outer annular plate 1331 and an inner annular plate 1332 set in the inner ring space of the outer annular plate 1331, the outer annular plate 1331 is adapted to the shape of the first outer ring magnet 13221 and the second outer ring magnet 13231, the inner annular plate 1332 is adapted to the shape of the first inner ring magnet 13222 and the second inner ring magnet 13232. The inner ring of the outer annular plate 1331 and the outer ring of the inner annular plate 1332 are separated by a certain distance from each other to form the clamping plate notch 1333, the inner annular plate 1332 also has a clamping plate through-hole 1334 coaxial with the photic hole 113.

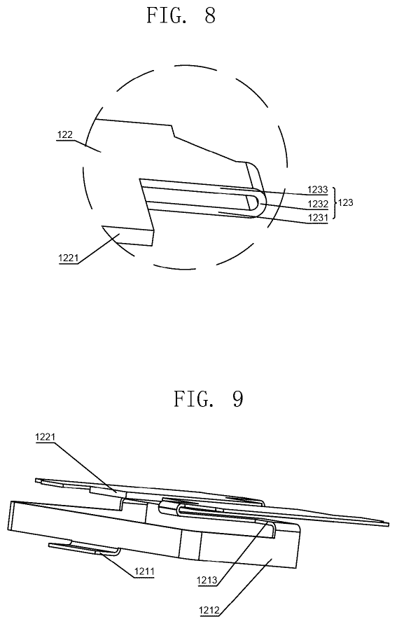

Referring to FIG. 8 to FIG. 9, in some embodiments, the second connection part 122 includes a thickening part 1221, the drive coil 134 is fixed to the thickening part 1221. Specifically, the side facing the photic hole 113 of the thickening part 1221 is used to support the sensor assembly 20, the side facing away from the photic hole 113 of the thickening part 1221 is fixed with the drive coil 134.

The first connecting part 121 is set around the outer wall of the support frame 131, and is fixedly connected to the bottom plate 112 of the housing 11 through the abutting part 1211, the end away from the bottom plate 112 of the first connecting part 121 is connected to the elastic arm 123.

The second connection part 122 is sheet-shaped. Along the direction of the optic axis 31 of the lens 30, the projection of the second connection part 122 covers a partial area of the through hole 1312 of the support frame 131.

In some embodiments, the elastic arm 123 includes a first arm 1231 connected to the first connecting part 121, a second arm 1232 bent and extending from the first arm 1231, and a third arm 1233 extending from the end of the second arm 1232 away from the first arm 1231, the third arm 1233 is connected to the second connection part 122, the first arm 1231 and the third arm 1233 are oppositely arranged.

In some embodiments, the first arm 1231 and the third arm 1233 are set parallel to each other.

In an embodiment, the elastic arm 123 is U-shaped. It can be understood that the shape of the elastic arm 123 includes but is not limited to a U-shape, and the specific shape can be set as needed.

In some embodiments, two second connection parts 122 have been set and are spaced apart from each other, each of the second connection part 122 is fixedly connected to the drive coil 134, the two second connection parts 122 are respectively connected to two different elastic arms 123, the extension directions of the third force arms 1233 in two different elastic arms 123 are opposite to each other, that is, there are two second connection parts 122 and two elastic arms 123, two second connection parts 122 and two elastic arms 123 are connected correspondingly.

In some embodiments, the support frame 131 includes a side wall 1313 fixed on the bottom plate 112, a top wall 1314 bend and extending from the end of the side wall 1313 away from the bottom plate 112 in the direction close to the optical axis 31, the side wall 1313 and the top wall 1314 are both fixedly connected to the magnetic circuit system 132. Among them, the side wall 1313 and the top wall 1314 are enclosed together to form the mounting cavity 1311, and the top wall 1314 bend and extending from the end of the side wall 1313 away from the bottom plate 112 in the direction close to the optical axis 31 is enclosed to form the through hole 1312. Among them, the clamping plate 133 is clamped between the top of the top wall 1314 and the magnetic circuit system 132, using to fix the magnetic circuit system 132 inside the the mounting cavity 1311 of the support frame 131.

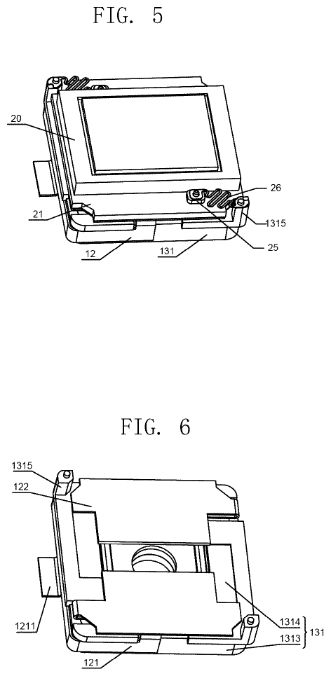

### Referring to FIG. 5 to FIG. 7, FIG. 12, in Some Embodiments, the Support Frame Also Includes a

connecting column 1315 extending from the top wall 1314 in the direction away from the bottom plate 112, the sensor assembly 20 also includes a connecting protrusion 25 set on the side of the circuit board 21 away from the bottom plate 112 and an elastic component 26 connecting the connecting protrusion 25 and the connecting column 1315.

In some embodiments, the support frame 131 is rectangular shaped, two connecting columns 1315 have been set and are diagonally arranged on the support frame 131, there are two connecting protrusions 25 and two elastic components 26, each of the connecting column 1315 is elastically connected to the corresponding connecting protrusion 25 through an elastic component 26. Furthermore, the elastic component 26 includes a first connecting component 261 fixedly connected to the connecting column 1315, a second connecting component 262 fixedly connected to the connecting protrusion 25, and a bending elastic component 263 connecting the first connecting component 261 and the second connecting component 262.

In the present invention, by diagonally arranging the connecting columns 1315 and connecting them with elastic components 26, further maintaining the stability of the entire structure and effectively controlling shaking can be ensured. In addition, the presence of the bending elastic component 263 can provide a buffering effect when subjected to impact or vibration, the force directly transmitted to other components is reducing, shake suppression effect is improved.

Referring to FIG. 9, in some embodiments, the first connecting part 121 includes a connecting side edge 1212 connected to the side wall 1313 and a connecting top edge 1213 connected to the top wall 1314.

In some embodiments, the connecting side edge 1212 is half frame shaped, and is set around the outer periphery of the side wall 1313. It can be understood that a half frame refers to part of a complete framework, rather than a perimeter completely enclosed. The connecting top edge 1213 extends from the end of connecting side edge 1212 away from the bottom plate 112 along the direction close to the optic axis, and the lower surface of the connecting top edge 1213 is abutting against the upper surface of the top wall 1314, the end of the connecting top edge 1213 away from the connecting side edge 1212 is connected to the elastic arm 123.

In some embodiments, the top wall includes an avoidance part 13141, using for avoiding the elastic arm 123. Specifically, the avoidance part 13141 is recessed in the upper end surface of the top wall 1314, and its position corresponds to the position of the elastic arm 123.

In some embodiments, a flexible circuit board is printed on the elastic support component 12, when the elastic support component 12 supports the circuit board 21 of the sensor assembly 20, the electrical connection between the sensor assembly 20 and the drive coil 134 is achieved through the flexible circuit board, so that the elastic support component 12 can conduct the current of the sensor assembly 20 to the drive coil 134.

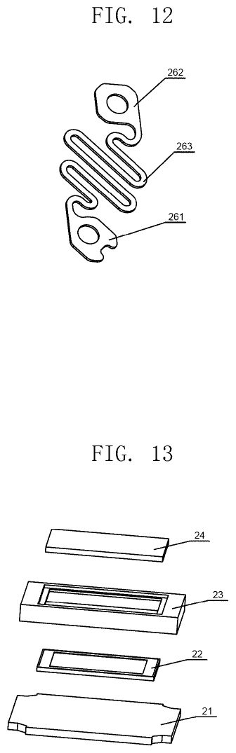

Referring to FIG. 1 and FIG. 13, the second aspect of an embodiment of this invention provides a lens module 100, includes a lens driving device 10, a sensor assembly 20, and a lens 30. The lens driving device 10 has a housing 11, and the sensor assembly 20 is arranged inside the housing 11, the sensor assembly 20 is connected to the elastic support component 12, the lens 30 is arranged at the photic hole 113 on the top of the housing 11, and the lens 30 is correspondingly arranged with the sensor assembly 20, among them, the lens 30 is arranged at the photic hole 113, along the direction of the optic axis 31 of the lens 30, the lens 30, the sensor assembly 20, and the lens driving device 10 are arranged in sequence, the lens driving device 10 is used to drive the sensor assembly 20 to move along the direction of the optic axis 31 of the lens 30.

Specifically, the current generated by the sensor assembly 20 is conducted to the drive coil 134 of the lens driving device 10 through the elastic support component 12, when there is current conduction in the drive coil 134, under the action of force generated by the interaction between the magnetic field of the drive coil 134 and the magnetic field of the magnetic circuit system 132, the sensor assembly 20 is driven to move along the direction of the optic axis 31 of the lens 30, and focal length adjustment has been achieved.

In the present invention, and in the design of fixed focus and anti-shake which is taking the sensor assembly 20 moving schemes, there is no need to reserve an extra moving space for the lens 30, the sensor assembly 20 can move precisely in a small space, so increasing the size of the screen opening of the lens 30 is unnecessary, the screen to body ratio can be effectively improved. In addition, compared with the existing lens 30 movement schemes, the present invention with the sensor assembly 20 moving schemes, as the sensor assembly 20 can move in the direction of the optic axis 31 directly, a larger range of optic axis 31 adjustment can be achieved, allowing for a larger field of view (FOV) under the same screen opening size.

The sensor assembly 20 includes a circuit board 21, a sensor 22, a sensor support frame 23, and a filter 24 which are sequentially stacked, the sensor support frame 23 is used to cover the sensor 22 on the circuit board 21, and the sensor support frame 23 has an installation groove which is adapted to the shape of the filter 24, and the filter 24 is set in the installation groove.

Specifically, the circuit board 21 is supported on and electrically connected to one side of the second connection part 122 of the elastic support component 12 near the photic hole 113, the side of the second connection part 122 away from the photic hole 113 is fixedly connected to the drive coil 134.

The third aspect of an embodiment of this invention provides AR glasses, the AR glasses includes the lens module 100.

It can be understood that the above embodiments are only exemplary embodiments adopted to illustrate the principles of the present invention, however the present invention is not limited to them. For ordinary technicians in this field, various modifications and improvements can be made without departing from the spirit and essence of the present invention, and these modifications and improvements are also considered within the scope of protection of the present invention.

What is claimed is:

1. A lens driving device, comprising:
a housing, the housing comprises a bottom plate and an upper cover that is covered on the bottom plate and enclosed to form an accommodation space with the bottom plate, the upper cover is provided with a photic hole communicated the accommodation space with the outside, the photic hole is used to communicate with a lens;
a sensor assembly, the sensor assembly located within the accommodation space, the sensor assembly comprises a circuit board and a sensor located on the side of the circuit board near the photic hole and electrically connected to the circuit board;
a drive assembly, the drive assembly located within the accommodation space, the drive assembly comprises a support frame fixed on the bottom plate, a magnetic circuit system fixed on the bottom plate, and a drive coil, the magnetic circuit system has a magnetic gap;
an elastic support component, the elastic support component comprises a first connecting part fixed on the support frame, a second connection part fixed on the circuit board, an abutting part fixed on the bottom plate, and an elastic arm connecting the first connecting part and the second connection part, the elastic support component suspends the sensor assembly within the accommodation space;
the drive coil is located on the side of the second connection part away from the circuit board, and extends into the magnetic gap, the drive coil cooperates with the magnetic circuit system to be used for driving the sensor assembly to move in the direction of an optic axis of the lens.

2. The lens driving device of claim 1, wherein the magnetic circuit system comprises a first magnetic circuit component fixed on the bottom plate and a second magnetic circuit component set on the side of the first magnetic circuit component facing away from the bottom plate; the second magnetic circuit component is set with the magnetic gap.

3. The lens driving device of claim 2, wherein the first magnetic circuit component comprises a first outer ring magnet, a first inner ring magnet, and a non-magnetic area set between the first outer ring magnet and the first inner ring magnet; the first inner ring magnet is set on the inner side of the first outer ring magnet; wherein the magnetic pole direction of the first outer ring magnet is opposite from that of the first inner ring magnet.

4. The lens driving device of claim 3, wherein the first magnetic circuit component is integrally formed using a quadrupole magnetization process.

5. The lens driving device of claim 3, wherein the second magnetic circuit component comprises a second outer ring magnet and a second inner ring magnet; the second inner ring magnet is set on the inner side of the second outer ring magnet; wherein the magnetic pole direction of the second outer ring magnet is opposite from that of the second inner ring magnet, and the second outer ring magnet and the second inner ring magnet are spaced apart from each other to form the magnetic gap.

6. The lens driving device of claim 5, wherein the first magnetic circuit component and the second magnetic circuit component are integrally formed using a quadrupole magnetization process.

7. The lens driving device of claim 2, wherein the magnetic circuit system also comprises a clamping plate located on the side of the second magnetic circuit component near the photic hole, the clamping plate is provided with a clamping plate notch communicated with the magnetic gap.

8. The lens driving device of claim 1, wherein the second connection part comprises a thickening part, the drive coil is fixed to the thickening part.

9. The lens driving device of claim 2, wherein the elastic arm comprises a first arm connected to the first connecting part, a second arm bent and extending from the first arm, and a third arm extending from the end of the second arm away from the first arm, the third arm is connected to the second connection part; the first arm and the third arm are oppositely arranged.

10. The lens driving device of claim 9, wherein two second connection parts have been set and are spaced apart from each other, each of the second connection part is fixedly connected to the drive coil, the two second connection parts are respectively connected to two different elastic arms, the extension directions of the third force arms in two different elastic arms are opposite to each other.

11. The lens driving device of claim 1, wherein the support frame comprises a side wall fixed on the bottom plate, a top wall bend and extending from the end of the side wall away from the bottom plate in the direction close to the optical axis, the side wall and the top wall are both fixedly connected to the magnetic circuit system.

12. The lens driving device of claim 11, wherein the support frame also comprises a connecting column extending from the top wall in the direction away from the bottom plate, the sensor assembly also comprises a connecting protrusion set on the side of the circuit board away from the bottom plate and an elastic component connecting the connecting protrusion and the connecting column.

13. The lens driving device of claim 11, wherein the first connecting part comprises a connecting side edge connected to the side wall and a connecting top edge connected to the top wall.

14. The lens driving device of claim 11, wherein the top wall comprises an avoidance part, using for avoiding the elastic arm.

15. A lens module, comprising:
a lens driving device of claim 1;
a lens, set at a through hole on the top of the housing, the lens is correspondingly set with the sensor assembly.
